(19) United States
(12) Patent Application Publication
(10) Pub. No.: US 2025/0327585 A1
(43) Pub. Date: Oct. 23, 2025

(54) Air Conditioner

(71) Applicant: Gree Electric Appliances, Inc. of Zhuhai, Zhuhai, Guangdong (CN)

(72) Inventors: Tiejun Zheng, Zhuhai, Guangdong (CN); Chao Wu, Zhuhai, Guangdong (CN); Jinhui Xu, Zhuhai, Guangdong (CN); Jian He, Zhuhai, Guangdong (CN); Xiaolong Chi, Zhuhai, Guangdong (CN)

(21) Appl. No.: 18/870,193

(22) PCT Filed: Apr. 28, 2023
(86) PCT No.: PCT/CN2023/091797

§ 371 Date: Nov. 27, 2024

(30) Foreign Application Priority Data
Aug. 11, 2022 (CN) 202210963547.6

(51) Int. Cl. F24F 1/0033

(52) U.S. Cl. CPC F24F 1/0033

(57) ABSTRACT

An air conditioner including a rotatable fan, which includes a rotatable volute and a motor arranged inside the volute. The motor is electrically connected with a power supply component through a motor wire. The motor wire includes a first wire segment connected with the motor directly, and arranged on the volute and moving synchronously with the volute; and a second wire segment electrically connected with the power supply component, electrically connected with the first wire segment through a rotation node which is located outside the volute, and having a preserved length to allow the volute to rotate to drive the wire body to move. The air conditioner in the present disclosure effectively solves the problem of wire loss caused by twisting of the motor wires for the rotatable fans in the air conditioner.

### CROSS-REFERENCE TO RELATED APPLICATIONS

This application is the United States National Phase of International Application No. PCT/CN2023/091797, filed Apr. 28, 2023, and claims priority to Chinese Patent Application No. 202210963547.6, filed Aug. 11, 2022, the disclosures of which are hereby incorporated by reference in their entireties.

### BACKGROUND OF THE INVENTION

### Field of the Invention

The present disclosure relates to the technical field of refrigeration, and in particular relates to air conditioners.

### Description of Related Art

A typical air conditioner (an indoor unit of the air conditioner) includes at least two air ports, one of which is only used for air outgoing, and the other of which is only used for air return, and airflow is made to flow between the two air ports via rotation of fans in the indoor unit of the air conditioner. With people's pursuit for comfort of the air conditioner increasing, the indoor unit of the air conditioner needs to have the air outgoing direction changed according to working modes. However, as blades of the fans have directional requirements, after the motor driving the blades to rotate is reversed, the direction of the airflow is hard to be changed, resulting in that the air outgoing direction of the indoor unit cannot be adjusted, and the unique air outgoing direction is difficult to meet the diversified demands of users. In some solutions, reverse outgoing of the air can be achieved by providing a plurality of mixed-flow fans and rotating the mixed-flow fans by 180 degrees in the indoor unit of the air conditioner.

A driving device, all in the form of a motor in cooperation with a rotating mechanism, for driving the fan to rotate is usually employed. It is a problem to be solved how to supply power to the motor of the fan while ensuring that motor wires are not twisted during rotation.

### SUMMARY OF THE INVENTION

In order to achieve the above objectives, the present disclosure provides an air conditioner including a rotatable fan, which includes a rotatable volute and a motor arranged inside the volute. The motor is electrically connected with a power supply component through a motor wire. The motor wire includes a first wire segment connected with the motor directly, the first wire segment is arranged on the volute and moving synchronously with the volute; and a second wire segment electrically connected with the power supply component, the second wire segment is electrically connected with the first wire segment through a rotation node which is located outside the volute, and the second wire segment have a preserved length to allow the volute to rotate to drive a wire body to move.

In some embodiments, the rotation node is an onboard connector.

In some embodiments, a plurality of the fans are provided, all of which are connected in turn, and all of which can rotate simultaneously to change orientation of an air outlet, with rotation axes of all the fans being collinear.

In some embodiments, a plurality of the first wire segments are provided, in one-to-one correspondence with the motors, and all the first wire segments are converged at the same rotation node.

In some embodiments, one second wire segment is provided, and all the first wire segments are electrically connected with the second wire segment through the rotation node.

In some embodiments, the air conditioner includes a driving device, which is drivingly connected with at least one of the fans to drive all the fans to rotate.

In some embodiments, the fan located at a head end of all the fans is in driving connection with the driving device, the head end being the end close to the driving device, and the rotation node is located at a position where the driving device is located.

In some embodiments, along a direction of all the fans from a tail end to the head end, the first wire segments corresponding to the fans pass through the other fans close to the head end in turn and are routed to the rotation node.

In other embodiments, a plurality of the fans are provided, which rotate independent of each other; a plurality of the first wire segments are provided, in one-to-one correspondence with the motors; and a plurality of the second wire segments are provided, which are connected with the first wire segments in one-to-one correspondence through one rotation node.

In other embodiments, the fan is internally provided with a wiring slot, in which the first wire segment is routed.

In other embodiments, the motor is hermetically arranged in a mounting case, the motor wire passes through the mounting case, the wire body of the motor wire is provided with a sealing ring, and the motor wire is hermetically connected with the mounting case through the sealing ring.

In some embodiments, the wire body of the motor wire is integrally formed with the sealing ring.

In some embodiments, the air conditioner includes an air duct machine.

In some embodiments, the fan includes any one of a mixed flow fan, an axial flow fan or a centrifugal fan.

### BRIEF DESCRIPTION OF THE DRAWINGS

FIG. 1 is a schematic view showing the internal structure of an air conditioner according to some embodiments of the present disclosure;

FIG. 2 is an enlarged schematic view showing partial structure of the air conditioner of FIG. 1;

FIG. 3 is a schematic structural view showing a motor and a mounting case of the air conditioner according to the embodiment of the present disclosure;

FIG. 4 is a schematic view showing arrangement of motor wires of the air conditioners

### DESCRIPTION OF THE INVENTION

The present disclosure will be described in further detail with reference to the attached drawings and specific embodiments, but it is not intended to limit the present disclosure.

In the related art, twisting resistance of the motor wires is achieved by two means: either by selecting a twisting-resistant wire material, or by extending the rotation path of the wire body to disperse the stress on the wire body during twisting thereby to avoid concentrated stress damage. These two means merely prolong the service life of the wire body, but cannot completely solve the problem of wire loss caused by twisting of the wires, and there is still the problem of wire loss caused by twisting of the motor wires for the rotatable fan in the air conditioner.

In an embodiment of the present disclosure, an air conditioner is provided to solve the problem of wire loss caused by twisting of motor wires for the rotatable fan in the air conditioner.

In this embodiment of the present disclosure, the motor wire is designed to be divided into multiple portions. The first wire segment is fixed to the volute and turns or rotates synchronously with the volute, so the motor wire located inside the volute may definitely not be twisted. Meanwhile, the rotation node between the second wire segment and the first wire segment is placed outside the volute, that is, the node where turning and rotation occurs is transferred to the outside of the volute, thus solving the problem of twisting and winding of the motor wire within the volute. Further, the rotation of the fan may necessarily lead to rotation of the motor wire, and this part of rotation amount for rotating the motor wire is borne by the second wire segment, which has sufficient preserved length for its own turning and rotation, so the second wire segment may not be twisted either. In this way, by designing the arrangement of and matching relationship between the multiple portions of the motor wire, the motor wire of the fan is prevented from being twisted during rotation of the fan, thus thoroughly eliminating the problem of wire loss caused by twisting of the wire.

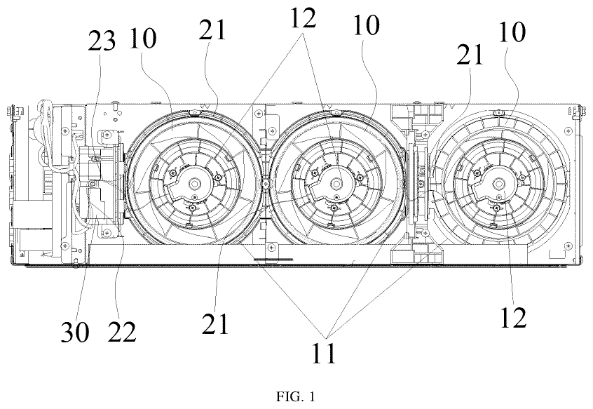

In order to solve the above problem, as shown in FIGS. 1 to 4, according to the embodiment of the present disclosure, an air conditioner is provided, which includes a rotatable fan 10 including a rotatable volute 11 and a motor 12 disposed inside the volute 11. The motor 12 is electrically connected with a power supply component 40 through a motor wire 20. The motor wire 20 includes a first wire segment 21 and a second wire segment 22. The first wire segment 21 is connected with the motor 12 directly, is fixedly arranged on the volute 11 and moves synchronously with the volute 11. The second wire segment 22 is electrically connected with the power supply component 40, is electrically connected with the first wire segment 21 through a rotation node 23 located outside the volute 11, and has a reserved length to allow the volute 11 to rotate to drive the wire body to move.

The position of the rotation node 23 is fixed, and the second wire segment 22 passes through the rotation node 23 and is movable within a threading hole of the rotation node 23, so that when the fan 10 rotates to drive a length segment of the second wire segment 22 between the fan 10 and the rotation node 23 to swing, the second wire segment 22 can move relative to the rotation node 23 to adapt to the rotation of the fan 10.

The motor wire 20 is designed to be divided into multiple portions. The first wire segment 21 is fixed to the volute 11 and turns or rotates synchronously with the volute, so the motor wire located inside the volute 11 may definitely not be twisted. Meanwhile, the rotation node 23 between the second wire segment 22 and the first wire segment 21 is placed outside the volute 11, that is, the node where turning and rotation occurs is transferred to the outside of the volute 11, thus solving the problem of twisting and winding of the motor wire inside the volute 11. Further, the rotation of the fan 10 may necessarily lead to rotation of the motor wire 20, and this part of rotation amount for rotating the motor wire 20 is borne by the second wire segment 22, which has a sufficient preserved length for its own turning and rotation, so the second wire segment 22 may not be twisted either. In this way, by designing the arrangement of and matching relationship between the multiple portions of the motor wire 20, the motor wire 20 of the fan 10 is prevented from being twisted during rotation of the fan 10, thus thoroughly eliminating the problem of wire loss caused by twisting of the wire.

To be specifically explained, the rotation node 23 is a position point where the first wire segment 21 and the second wire segment 22 are connected. With the rotation node 23 serving as an intersection point of two types of rotation trajectories of the motor wire 20, the first wire segment 21 rotates synchronously with the volute 11; behind the rotation node 23, the rotation of the second wire segment 22 depends on the rotation node 23, the rotation process of the second wire segment 23 is determined by the structure and rotation trajectory of the rotation node 23, and the second wire segment 22 is used to absorb the rotation amount of the motor wire 20; and the rotation node 23 separates the rotation of the first wire segment 21 from that of the second wire segment 22. The rotation node 23 may be a fixed structure such as a fixed clip, a fixed lock catch and the like, at the position where the two wire segments of the motor wire 20 are connected.

In this embodiment, the rotation node 23 is an onboard connector. That is to say, in this embodiment, the first wire segment 21 and the second wire segment 22 are electrically connected through the on-board connector, which is a socket with a wire insertion hole and is generally used for circuit connection. The structure of the on-board connector belongs to the prior art and thus will not be described in detail here. The selection of the onboard connector in this embodiment is advantageous in that it not only can fulfill the electrical connection between the first wire segment 21 and the second wire segment 22, but also can separate the rotation trajectory of the first wire segment 21 from that of the second wire segment 22, thus playing a dual-purpose role. Even if the on-board connector is mounted outside the volute 11, the on-board connector may rotate with the volute 11, and the process of synchronous rotation of the first wire segment 21 and the volute 11 remains unchanged, while the second wire segment 22 connected to the on-board connector absorbs the rotation amount of the on-board connector (also the rotation amount of the motor wire 20) to rotate by itself, and the second wire segment 22 has sufficient length to support its rotation.

Referring to FIG. 1, a plurality of the fans 10 are provided, all of which are connected in turn, and all of which can rotate at the same time to change the orientation of the air outlet, with rotation axes of all the fans 10 being collinear. For example, all the fans 10 are arranged side by side along a length direction of the air conditioner, and the rotation axes of the fans 10 may be consistent with the length direction of the air conditioner, so that when all the fans 10 rotate synchronously, the orientation of the air outlet can be adjusted up and down to adapt to different working modes of the air conditioner.

The rotation axes of all the fans 10 are in collinear arrangement, there is no need to reserve movable gaps between the fans 10, and the gap between the fans 10 may be reduced or even cancelled (in the case of the fans being connected together), thus greatly reducing the space occupation rate of the fan assembly, shortening the overall length of the air conditioner and making the product more competitive.

The number of the first wire segments 21 is adjusted according to the number of the fans 10. A plurality of the first wire segments 21 are provided, in one-to-one correspondence with the motors 12, and all the first wire segments 21 are converged at the rotation node 23. Each fan 10 is separately equipped with one first wire segment 21.

In the embodiment shown in FIG. 4, one second wire segment 22 is provided, and all the first wire segments 21 are electrically connected with the second wire segment 22 through the rotation node 23. The power supply component 40 is directly connected with the plurality of fans 10 to supply power thereto through the one second wire segment 22. In some embodiments, the air conditioner includes a driving device 30, to which the at least one fan 10 is connected, and the driving device 30 is in driving connection with the fans 10 to drive all the fans 10 to rotate. The number of the driving devices 30 may be two or three. In the case of two driving devices 20 being provided, one of the driving devices 30 may be used to drive one or more fans 10 and the other driving device 30 is used to drive the remaining fans 10, thus capable of reducing the burden of the individual driving device 30. Further, when one of the driving devices 30 fails, the fans can be driven by the other driving device 30, thus ensuring the running reliability of the fans.

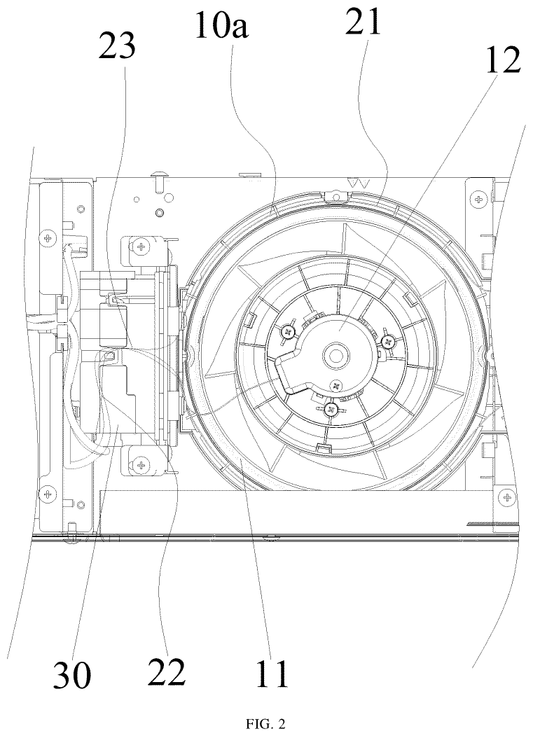

As shown in FIGS. 1 and 2, the fan 10 located at a head end of all the fans 10 is connected with the driving device 30 in a driving manner, and the rotation node 23 is located at a position where the driving device 30 is located, wherein the head end is the end closest to the driving device 30, and a tail end is the end farthest from the driving device 30. Along a direction of all the fans 10 from the tail end to the head end, the first wire segment 21 corresponding to the fan 10 passes through the other fans 10 in turn and is routed to the rotation node 23. The fans 10 are such configured that the rotation axes of all the fans 10 are collinear. Referring to the arrangement of the fans in FIG. 1, in the direction from left to right, on the leftmost side of FIG. 1 is the fan 10 located at the head end of all the fans, and on the rightmost side of FIG. 1 is the fan 10 located at the tail end of all the fans. The motor wire 29 is routed in a direction from right to left in FIG. 1, passing through the middle fan 10 and the leftmost fan 10 in turn and being converged at the rotation node 23 where the driving device 30 is located.

In other embodiments, a plurality of the fans 10 are provided, which rotate independently. A plurality of the first wire segments 21 are provided, in one-to-one correspondence with the motors 12; and a plurality of the second wire segments 22 are provided, which are connected with the first wire segments 21 in one-to-one correspondence through the one rotation node 23. In order to facilitate control of rotational speed of different fans 10, each motor wire 20 is managed separately for control of its electrical signal, thereby to control the rotation of each fan 10.

In some embodiments, as shown in FIG. 2, the fan 10 is internally provided with a wiring slot 10a, in which the first wire segment 21 is routed. The wiring slot 10a is arranged on the inner wall of the volute 11, which can enable synchronous rotation of the first wire segment 21 of the motor wire 20 without affecting the energy efficiency of the fan 10.

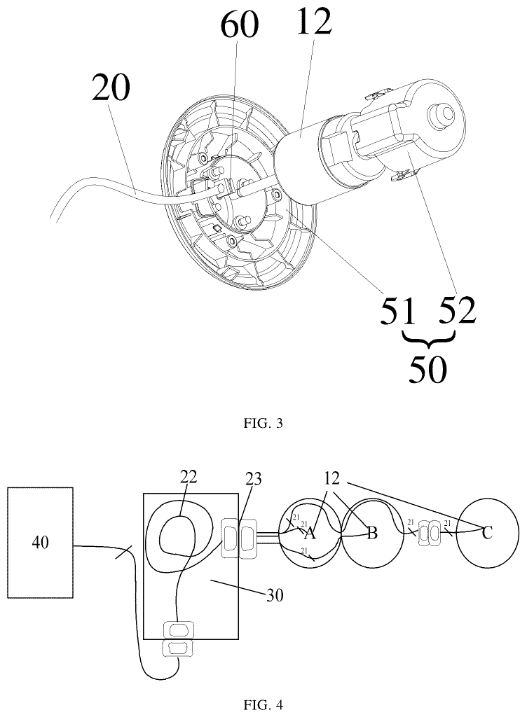

The fan 10 as an entirety is located in the air duct where condensation tends to occur, and the motor 12 inside the fan 10 may be subjected to the problem of condensation due to the exchange of cold and hot air in the cavity of the air duct. The condensation point position extends from the interface of the motor wire 20 to the interior of the motor 12, leading to the presence of scarce air inside the motor 12, and switching between the heating mode and the cooling mode may cause the problem of condensation. In the long run, it will corrode and destroy the enameled wires and motherboard devices inside the motor 12, thus damaging the motor 12. In order to solve the above problems, in this embodiment, the motor 12 is hermetically arranged in a mounting case 50, the motor wire 20 passes through the mounting case 50, a wire body of the motor wire 20 is provided with a sealing ring 60, and the motor wire 20 is hermetically connected with the mounting case 50 through the sealing ring 60, as shown in FIG. 3. The structure of the mounting case 50 is an integral combination of a front end cover 51 and a rear cover 52, so that the motor 12 is located inside the mounting case 50. By sealing with the sealing ring 60 to prevent moisture from entering the interior of the mounting case 50, the problem of condensation can be avoided from the motor.

In order to facilitate production as well as assembly and disassembly, the wire body of the motor wire 20 and the sealing ring 60 are integrally formed. Upon assembling and disassembling, it only needs to directly operate the motor wire 20, with no special operation on mounting or dismounting the sealing ring 60. As both the wire body and the sealing ring 60 can be made of insulating rubber materials, the difficulty in production is very low, and it is easier to reduce the cost compared with independent manufacturing.

In this embodiment, the air conditioner is an air duct machine. The fan 10 is any one of a mixed flow fan, an axial flow fan or a centrifugal fan. In this embodiment, the fan 10 is a mixed flow fan. The mixed flow fan is the one between an axial-flow mixed flow fan and a centrifugal mixed flow fan. Impellers of the mixed flow fan drive the air to perform both centrifugal movement and axial movement, and the airflow movement inside the volute is a mixture of two movement forms, i.e. axial flow movement and centrifugal movement, thus called “mixed flow”. As the mixed flow fan can not only be made small in volume, but also ensure the flow direction and air pressure of the airflow, the mixed flow fan is mounted in the air duct machine to realize reversibility of the wind direction and change the air outgoing direction. In some other embodiments not shown in the figure, the fan 10 may also be an axial flow fan or a centrifugal fan.

A housing of the air duct machine is provided with a lower air outlet and a side air outlet, and the fan 10 has a first orientation and a second orientation. When the air duct machine is in the cooling mode, the fan 10 is in the first orientation, and the air enters through the lower air inlet and exists through the side air outlet. When the air duct machine is in the heating mode, the fan 10 is in the second orientation, and the air enters through the side air inlet and exists through the lower air outlet.

In some embodiments, the air duct machine further includes a mounting bracket, to which all of the fans 10 are connected. Specifically, as shown in FIG. 1, a plurality of the fans 10 are “strung” together like candied haws, with every two adjacent fans 10 being fixed to each other. For example, a plurality of the fans 10 are arranged side by side along the length direction of the air duct machine. Therefore, in order to simplify the overall assembly structure, the mounting brackets may be arranged on the fans 10 located at both ends respectively, and when assembled, the fans 10 and the mounting brackets are formed as a whole, and the fans 10 are fixed inside the air duct through the mounting brackets. In the mounting process, the fans 10 are mounted on the mounting brackets first, and then the mounting brackets are fixed inside the air duct. Upon dismounting, the mounting brackets are dismounted first, and then the fans 10 are taken out together. Compared with the conventional air duct machine with a rotatable fan, the dismounting and mounting process of the operator in operation is more simplified. Moreover, after the fans 10 and the mounting brackets are removed as a whole, the fan 10 can be disassembled and repaired in a spacious and bright place, which makes the operation process more convenient and improves the work efficiency.

It should be noted that the terminology used here is only for describing the specific embodiments and is not intended to limit the exemplary embodiments according to the present application. As used herein, the singular form is also intended to include the plural form unless clearly indicated by the context. Furthermore, it should be understood that when the terms “contain” and/or “comprise” are used in this description, they specify the presence of a feature, a step, an operation, a device, an assembly and/or a combination thereof.

It should be noted that the terms “first”, “second” and the like in the description and claims of the present application and in the above drawings are used to distinguish similar objects from each other and are not necessarily used to describe a specific order or sequence. It should be understood that the terms so used can be interchanged under appropriate circumstances, so that the embodiments of the present application described herein can be implemented in other orders than those illustrated or described herein.

Of course, the above described is the preferred embodiment of the present disclosure. It should be pointed out that for those skilled in the art, many modifications and embellishments can be made without departing from the basic principles of the present disclosure, and these modifications and embellishments are also regarded as being within the protection scope of the present disclosure.

1. An air conditioner, comprising a rotatable fan which comprises a rotatable volute, and a motor disposed inside the volute and electrically connected with a power supply component through a motor wire, wherein the motor wire comprises:
a first wire segment, connected with the motor directly, the first wire segment is arranged on the volute and moving synchronously with the volute; and
a second wire segment, electrically connected with the power supply component, the second wire segment is electrically connected with the first wire segment through a rotation node which is located outside the volute, and the second wire segment have a preserved length to allow the volute to rotate to drive a wire body to move.

2. The air conditioner according to claim 1, wherein the rotation node is an onboard connector.

3. The air conditioner according to claim 1, wherein a plurality of the fans are provided, all of which are connected in turn, and all of which are capable of rotating simultaneously to change orientation of an air outlet, with rotation axes of all the fans being collinear.

4. The air conditioner according to claim 3, wherein a plurality of the first wire segments are provided, in one-to-one correspondence with the motors, and all the first wire segments are converged at the same rotation node.

5. The air conditioner according to claim 4, wherein one second wire segment is provided, and all the first wire segments are electrically connected with the second wire segment through the rotation node.

6. The air conditioner according to claim 4 wherein the air conditioner comprises a driving device, which is drivingly connected with at least one of the fans to drive all the fans to rotate.

7. The air conditioner according to claim 6, wherein the fan located at a head end of all the fans is in driving connection with the driving device, the head end being the end close to the driving device, and the rotation node is located at a position where the driving device is located.

8. The air conditioner according to claim 7, wherein along a direction of all the fans from a tail end to the head end, the first wire segments corresponding to the fan pass through the other fans close to the head end in sequence and are routed to the rotation node.

9. The air conditioner according to claim 1, wherein a plurality of the fans are provided, which rotate independent of each other; a plurality of the first wire segments are provided, in one-to-one correspondence with the motors; and a plurality of the second wire segments are provided, which are connected with the first wire segments in one-to-one correspondence through-one rotation node.

10. The air conditioner according to claim 1, wherein the fan is internally provided with a wiring slot, in which the first wire segment is routed.

11. The air conditioner according to claim 1, wherein the motor is hermetically arranged in a mounting case, the motor wire passes through the mounting case, the wire body of the motor wire is provided with a sealing ring, and the motor wire is hermetically connected with the mounting case through the sealing ring.

12. The air conditioner according to claim 11, wherein the wire body of the motor wire is integrally formed with the sealing ring.

13. The air conditioner according to claim 1, wherein the air conditioner comprises an air duct machine.

14. The air conditioner according to claim 1, wherein the fan comprises any one of a mixed flow fan, an axial flow fan or a centrifugal fan.
